(19) United States
(12) Patent Application Publication
(10) Pub. No.: US 2026/0057457 A1
(43) Pub. Date: Feb. 26, 2026

(54) SYSTEM

(71) Applicant: SoftBank Group Corp., Tokyo (JP)

(72) Inventor: Masaki HAMADA, Tokyo (JP)

(21) Appl. No.: 19/297,264

(22) Filed: Aug. 12, 2025

(30) Foreign Application Priority Data
Aug. 23, 2024 (JP) 2024-142044

(51) Int. Cl. G06Q 50/02; G06V 10/764; G06V 20/52

(52) U.S. Cl. CPC G06Q 50/02; G06V 10/764; G06V 20/52

(57) ABSTRACT

The system according to the embodiment includes a collection unit, an analysis unit, a prediction unit, and a provision unit. The collection unit collects data. The analysis unit analyzes the data collected by the collection unit. The prediction unit performs simulation prediction based on the analysis results obtained by the analysis unit. The provision unit provides the prediction results obtained by the prediction unit.

### CROSS-REFERENCE TO RELATED APPLICATION

The present application claims priority to and incorporates by reference the entire contents of Japanese Patent Application No. 2024-142044 filed in Japan on Aug. 23, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that it is difficult to accurately grasp the trends of beneficial and harmful insects in farmland and to predict their impact on yield and production quality.

### SUMMARY OF THE INVENTION

The system according to the embodiment includes a collection unit, an analysis unit, a prediction unit, and a provision unit. The collection unit collects data. The analysis unit analyzes the data collected by the collection unit. The prediction unit performs simulation prediction based on the analysis results obtained by the analysis unit. The provision unit provides the prediction results obtained by the prediction unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

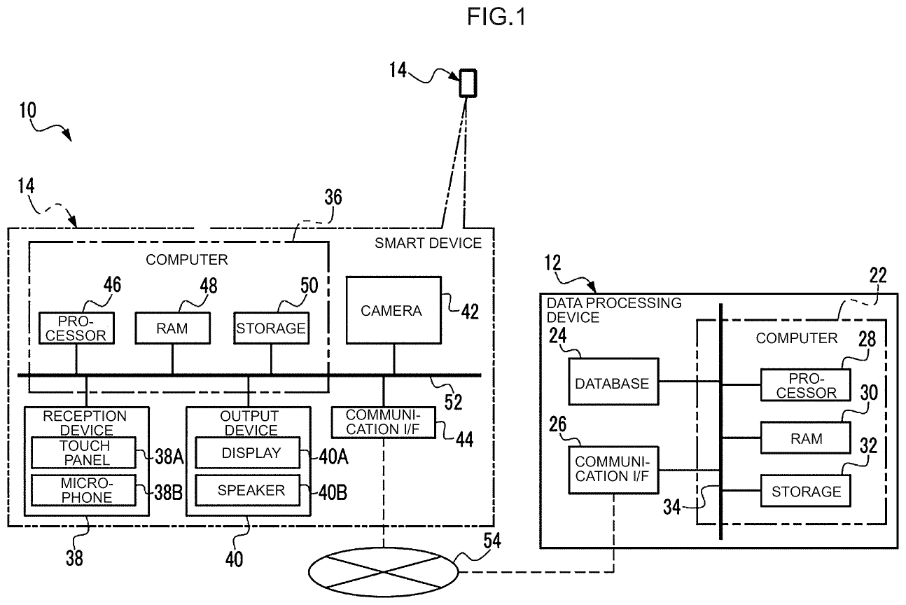

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

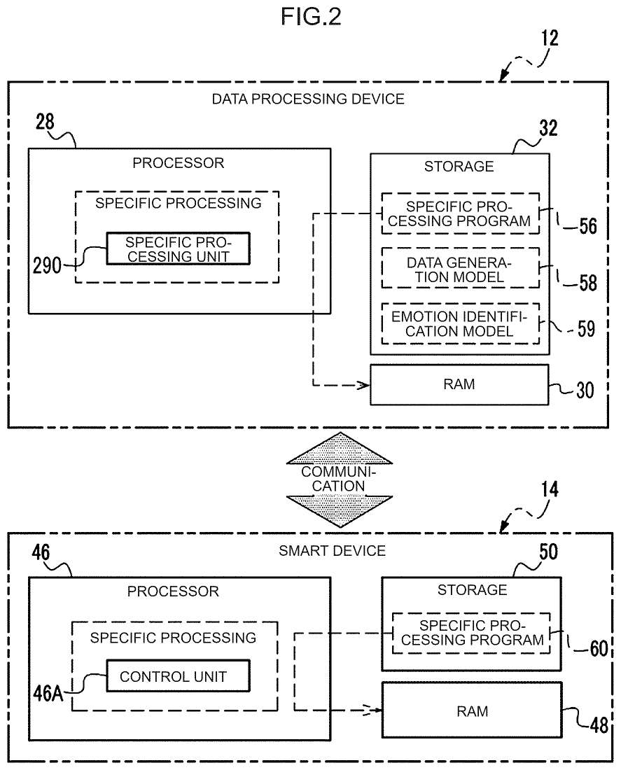

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The agricultural support system according to the embodiment of the present invention is a system that monitors the types, number of occurrences, occurrence times, and frequencies of beneficial and harmful insects in farmland or cultivated land using fixed-point surveillance cameras and collects such data. The collected data is analyzed by AI, and the correlation between the abundance of beneficial and harmful insects and the yield or production quality is simulated and predicted. This makes it possible to improve the productivity of pesticide-free and organic farming. For example, the agricultural support system installs fixed-point surveillance cameras in farmland or cultivated land and periodically observes the types, number of occurrences, occurrence times, and frequencies of beneficial and harmful insects. For example, the camera takes images at regular intervals, and the images are analyzed to identify the types and numbers of beneficial and harmful insects. This data is transmitted to and stored on a cloud server. Next, the collected data is analyzed by AI. The AI simulates and predicts the correlation between the abundance of beneficial and harmful insects and the yield or production quality. For example, it is predicted that an increase in the abundance of beneficial insects will increase the yield, while an increase in the abundance of harmful insects will decrease the yield. Based on such simulation results, agricultural stakeholders can take measures to improve the productivity of pesticide-free and organic farming. Thus, the agricultural support system enables agricultural stakeholders to grasp the trends of beneficial and harmful insects in real time and take appropriate measures. In addition, simulation prediction by AI makes it possible to improve the productivity of pesticide-free and organic farming. For example, by harvesting in periods when the abundance of beneficial insects increases, the yield can be maximized. Also, by taking pest control measures in periods when the abundance of harmful insects increases, production quality can be maintained. In this way, the agricultural support system is extremely useful for agricultural stakeholders and serves as a powerful tool for improving the productivity of pesticide-free and organic farming.

The agricultural support system according to the embodiment includes a collection unit, an analysis unit, a prediction unit, and a provision unit. The collection unit collects data. The data may include, for example, sensor data, image data, text data, etc., but is not limited thereto. The collection unit may, for example, periodically observe the types, number of occurrences, occurrence times, and frequencies of beneficial and harmful insects using a fixed-point surveillance camera. The collection unit may also transmit data to a cloud server. For example, the collection unit may transmit image data captured by a fixed-point surveillance camera to a cloud server for storage. The analysis unit analyzes the data collected by the collection unit. The analysis may be performed using, for example, machine learning or deep learning, but is not limited thereto. For example, the analysis unit may analyze data using a machine learning algorithm. The analysis unit may also analyze data using a deep learning algorithm. The analysis unit may also combine different analysis algorithms to improve analysis accuracy. For example, the analysis unit may combine machine learning and deep learning to improve analysis accuracy. The prediction unit performs simulation prediction based on the analysis results obtained by the analysis unit. The simulation prediction may, for example, predict the correlation between the abundance of beneficial and harmful insects and the yield or production quality, but is not limited thereto. For example, the prediction unit may predict that an increase in the abundance of beneficial insects will increase the yield. The prediction unit may also predict that an increase in the abundance of harmful insects will decrease the yield. The prediction unit may also provide multiple prediction results based on different scenarios. For example, the prediction unit may provide prediction results based on scenarios that take into account weather changes. The provision unit provides the prediction results obtained by the prediction unit. The provision may be made, for example, to agricultural stakeholders, but is not limited thereto. For example, the provision unit provides the prediction results to agricultural stakeholders so that appropriate agricultural measures can be taken. The provision unit may also propose measures to improve the productivity of pesticide-free or organic farming. For example, the provision unit may propose measures such as harvesting in periods when the abundance of beneficial insects increases, or pest control measures in periods when the abundance of harmful insects increases. Thus, the agricultural support system according to the embodiment can efficiently perform data collection, analysis, simulation prediction, and provision. Some or all of the above-described processing in the provision unit may be performed using AI, or may be performed without using AI. For example, the provision unit may use an AI model that takes the prediction results obtained by the prediction unit as input and outputs countermeasure proposals for agricultural stakeholders to propose measures.

The collection unit can periodically observe the types, number of occurrences, occurrence times, and frequencies of beneficial and harmful insects using a fixed-point surveillance camera. The fixed-point surveillance camera may include, for example, high-resolution cameras, infrared cameras, 360-degree cameras, etc., but is not limited thereto. The collection unit may, for example, observe the types of beneficial and harmful insects using a high-resolution camera. The collection unit may also observe the trends of beneficial and harmful insects at night using an infrared camera. The collection unit may also observe the trends of beneficial and harmful insects over a wide area using a 360-degree camera. Thus, by using a fixed-point surveillance camera, the trends of beneficial and harmful insects can be accurately observed. Some or all of the above-described processing in the collection unit may be performed using AI, or may be performed without using AI. For example, the collection unit may input image data captured by a fixed-point surveillance camera into a generative AI and have the generative AI identify the types and numbers of beneficial and harmful insects.

The collection unit can transmit data to a cloud server. The cloud server may include, for example, AWS (registered trademark), Google (registered trademark) Cloud, Microsoft Azure (registered trademark), etc., but is not limited thereto. The collection unit may, for example, transmit data using AWS. The collection unit may also transmit data using Google Cloud. The collection unit may also transmit data using Microsoft Azure. Thus, by transmitting data to a cloud server, data storage and analysis are streamlined. Some or all of the above-described processing in the collection unit may be performed using AI, or may be performed without using AI. For example, the collection unit may have a generative AI select the data to be transmitted to the cloud server.

The analysis unit can analyze data using machine learning or deep learning. Machine learning algorithms may include, for example, linear regression, decision trees, random forests, etc., but are not limited thereto. The analysis unit may, for example, analyze data using linear regression. The analysis unit may also analyze data using decision trees. The analysis unit may also analyze data using random forests. Deep learning algorithms may include, for example, neural networks, CNNs (convolutional neural networks), RNNs (recurrent neural networks), etc., but are not limited thereto. The analysis unit may, for example, analyze data using neural networks. The analysis unit may also analyze data using CNNs. The analysis unit may also analyze data using RNNs. Thus, by using machine learning or deep learning, the accuracy of data analysis is improved. Some or all of the above-described processing in the analysis unit may be performed using AI, or may be performed without using AI. For example, the analysis unit may input data obtained from the collection unit into a generative AI and have the generative AI perform data analysis.

The prediction unit can simulate and predict the correlation between the abundance of beneficial and harmful insects and the yield or production quality. Methods for measuring correlation may include, for example, correlation coefficients, regression analysis, factor analysis, etc., but are not limited thereto. The prediction unit may, for example, predict the correlation between the abundance of beneficial and harmful insects and the yield using a correlation coefficient. The prediction unit may also predict the correlation between the abundance of beneficial and harmful insects and the production quality using regression analysis. The prediction unit may also predict the correlation between the abundance of beneficial and harmful insects and the yield or production quality using factor analysis. Thus, by simulating and predicting the correlation between the abundance of beneficial and harmful insects and the yield or production quality, agricultural productivity can be improved. Some or all of the above-described processing in the prediction unit may be performed using AI, or may be performed without using AI. For example, the prediction unit may input the analysis results obtained from the analysis unit into a generative AI and have the generative AI perform simulation prediction of the correlation.

The provision unit can provide the prediction results to agricultural stakeholders. Agricultural stakeholders may include, for example, farmers, agricultural consultants, agricultural researchers, etc., but are not limited thereto. The provision unit may, for example, provide prediction results to farmers. The provision unit may also provide prediction results to agricultural consultants. The provision unit may also provide prediction results to agricultural researchers. Thus, by providing prediction results to agricultural stakeholders, appropriate agricultural measures can be taken. Some or all of the above-described processing in the provision unit may be performed using AI, or may be performed without using AI. For example, the provision unit may input the prediction results obtained from the prediction unit into a generative AI and have the generative AI execute the method of providing information to agricultural stakeholders.

The provision unit can propose measures to improve the productivity of pesticide-free or organic farming. The definition of pesticide-free may include, for example, not using specific pesticides, using natural pest control methods, etc., but is not limited thereto. The definition of organic farming may include, for example, meeting the standards for obtaining organic certification, not using chemical fertilizers or synthetic pesticides, etc., but is not limited thereto. The provision unit may, for example, propose a measure to harvest in periods when the abundance of beneficial insects increases as a pesticide-free measure. The provision unit may also propose pest control measures in periods when the abundance of harmful insects increases as an organic farming measure. The provision unit may also propose the timing of fertilization or irrigation to improve the productivity of pesticide-free or organic farming. For example, the provision unit may propose a measure to fertilize in periods when the abundance of beneficial insects increases. The provision unit may also propose a measure to irrigate in periods when the abundance of harmful insects increases. Thus, by proposing measures to improve the productivity of pesticide-free or organic farming, agricultural efficiency is improved. Some or all of the above-described processing in the provision unit may be performed using AI, or may be performed without using AI. For example, the provision unit may input the prediction results obtained from the prediction unit into a generative AI and have the generative AI execute proposals for pesticide-free or organic farming measures.

The collection unit can learn the behavioral patterns of beneficial and harmful insects and automatically set the optimal observation timing. The collection unit may, for example, learn the time periods when beneficial insects are most active and collect data during those periods. The collection unit may also learn the time periods when harmful insects are expected to appear and collect data during those periods. The collection unit may also learn the seasonal behavioral patterns of beneficial and harmful insects and set the optimal observation timing. Thus, by learning the behavioral patterns of beneficial and harmful insects, the optimal observation timing can be set. Some or all of the above-described processing in the collection unit may be performed using AI, or may be performed without using AI. For example, the collection unit may input behavioral data of beneficial and harmful insects into a generative AI and have the generative AI set the optimal observation timing.

The collection unit can collect data under different weather conditions and analyze the impact of environmental changes. The collection unit may, for example, collect data during rainy weather and analyze the behavioral patterns of beneficial and harmful insects. The collection unit may also collect data during clear weather and analyze the behavioral patterns of beneficial and harmful insects. The collection unit may also collect data according to temperature changes and analyze the behavioral patterns of beneficial and harmful insects. Thus, by collecting data under different weather conditions, the impact of environmental changes can be analyzed. Some or all of the above-described processing in the collection unit may be performed using AI, or may be performed without using AI. For example, the collection unit may input weather data into a generative AI and have the generative AI analyze the impact of environmental changes.

The collection unit can cooperate multiple cameras to collect wide-area data and enable detailed spatial analysis. The collection unit may, for example, install multiple cameras and collect wide-area data. The collection unit may also integrate data between cameras and perform detailed spatial analysis. The collection unit may also adjust the positions of the cameras and set the optimal data collection range. Thus, by cooperating multiple cameras, wide-area data can be collected and detailed spatial analysis becomes possible. Some or all of the above-described processing in the collection unit may be performed using AI, or may be performed without using AI. For example, the collection unit may input data obtained from multiple cameras into a generative AI and have the generative AI perform spatial analysis.

The collection unit can collect data from different regions based on geographic information and perform analysis that takes regional characteristics into account. The collection unit may, for example, collect data taking into account the weather conditions of different regions. The collection unit may also collect data taking into account the soil conditions of different regions. The collection unit may also collect data taking into account the vegetation conditions of different regions. Thus, by collecting data based on geographic information, analysis that takes regional characteristics into account becomes possible. Some or all of the above-described processing in the collection unit may be performed using AI, or may be performed without using AI. For example, the collection unit may input geographic information into a generative AI and have the generative AI perform data collection that takes regional characteristics into account.

The collection unit can collect information from social media to supplement information on the occurrence of beneficial and harmful insects. The collection unit may, for example, analyze posts on social media and collect information on the occurrence of beneficial and harmful insects. The collection unit may also analyze check-in information on social media and collect information on the occurrence of beneficial and harmful insects. The collection unit may also analyze image posts on social media and collect information on the occurrence of beneficial and harmful insects. Thus, by collecting information from social media, information on the occurrence of beneficial and harmful insects can be supplemented. Some or all of the above-described processing in the collection unit may be performed using AI, or may be performed without using AI. For example, the collection unit may input post data from social media into a generative AI and have the generative AI collect information on the occurrence of beneficial and harmful insects.

The collection unit can customize the collection method based on past data to achieve efficient data collection. The collection unit may, for example, analyze past data and set the optimal data collection method. The collection unit may also adjust the collection frequency based on past data. The collection unit may also adjust the collection range based on past data. Thus, by customizing the collection method based on past data, efficient data collection becomes possible. Some or all of the above-described processing in the collection unit may be performed using AI, or may be performed without using AI. For example, the collection unit may input past data into a generative AI and have the generative AI customize the collection method.

The analysis unit can perform detailed behavioral analysis based on ecological information of beneficial and harmful insects. The analysis unit may, for example, analyze the activity time zones and behavioral patterns based on the ecological information of beneficial insects. The analysis unit may also analyze the occurrence times and behavioral patterns based on the ecological information of harmful insects. The analysis unit may also analyze interactions based on the ecological information of beneficial and harmful insects. Thus, by performing detailed behavioral analysis based on the ecological information of beneficial and harmful insects, analysis accuracy is improved. Some or all of the above-described processing in the analysis unit may be performed using AI, or may be performed without using AI. For example, the analysis unit may input ecological data of beneficial and harmful insects into a generative AI and have the generative AI perform behavioral analysis.

The analysis unit can combine different analysis algorithms to improve analysis accuracy. The analysis unit may, for example, combine machine learning and deep learning to improve analysis accuracy. The analysis unit may also combine different machine learning algorithms to improve analysis accuracy. The analysis unit may also combine different data analysis methods to improve analysis accuracy. Thus, by combining different analysis algorithms, analysis accuracy is improved. Some or all of the above-described processing in the analysis unit may be performed using AI, or may be performed without using AI. For example, the analysis unit may input different analysis algorithms into a generative AI and have the generative AI improve analysis accuracy.

The analysis unit can learn from past analysis results and continuously improve the analysis model. The analysis unit may, for example, improve the analysis model based on past analysis results. The analysis unit may also learn from past analysis results to improve analysis accuracy. The analysis unit may also introduce new analysis methods based on past analysis results. Thus, by learning from past analysis results, the analysis model can be continuously improved. Some or all of the above-described processing in the analysis unit may be performed using AI, or may be performed without using AI. For example, the analysis unit may input past analysis results into a generative AI and have the generative AI improve the analysis model.

The analysis unit can integrate different data sources for analysis. The analysis unit may, for example, integrate weather data and analyze the behavioral patterns of beneficial and harmful insects. The analysis unit may also integrate soil data and analyze the behavioral patterns of beneficial and harmful insects. The analysis unit may also integrate weather data and soil data and analyze the behavioral patterns of beneficial and harmful insects. Thus, by integrating different data sources, analysis accuracy is improved. Some or all of the above-described processing in the analysis unit may be performed using AI, or may be performed without using AI. For example, the analysis unit may input weather data and soil data into a generative AI and have the generative AI perform integrated data analysis.

The analysis unit can refer to relevant academic papers to improve the reliability of analysis results. The analysis unit may, for example, refer to academic papers on beneficial and harmful insects to improve the reliability of analysis results. The analysis unit may also refer to academic papers on weather data to improve the reliability of analysis results. The analysis unit may also refer to academic papers on soil data to improve the reliability of analysis results. Thus, by referring to relevant academic papers, the reliability of analysis results is improved. Some or all of the above-described processing in the analysis unit may be performed using AI, or may be performed without using AI. For example, the analysis unit may input academic paper data into a generative AI and have the generative AI improve the reliability of analysis results.

The analysis unit can visualize analysis results so that users can intuitively understand them. The analysis unit may, for example, visualize analysis results in graphs or charts. The analysis unit may also display analysis results on a map so that users can intuitively understand them. The analysis unit may also visualize analysis results with animations so that users can intuitively understand them. Thus, by visualizing analysis results, users can intuitively understand them more easily. Some or all of the above-described processing in the analysis unit may be performed using AI, or may be performed without using AI. For example, the analysis unit may input analysis results into a generative AI and have the generative AI perform visualization.

The prediction unit can perform long-term prediction taking into account the seasonal variations of beneficial and harmful insects. The prediction unit may, for example, take into account the seasonal variations of beneficial insects and perform long-term prediction. The prediction unit may also take into account the seasonal variations of harmful insects and perform long-term prediction. The prediction unit may also take into account the seasonal variations of both beneficial and harmful insects and perform long-term prediction. Thus, by taking into account the seasonal variations of beneficial and harmful insects, long-term prediction becomes possible. Some or all of the above-described processing in the prediction unit may be performed using AI, or may be performed without using AI. For example, the prediction unit may input seasonal variation data into a generative AI and have the generative AI perform long-term prediction.

The prediction unit can provide multiple prediction results based on different scenarios. The prediction unit may, for example, provide prediction results based on scenarios that take into account weather changes. The prediction unit may also provide prediction results based on scenarios that take into account pesticide use. The prediction unit may also provide prediction results based on scenarios that take into account both weather changes and pesticide use. Thus, by providing multiple prediction results based on different scenarios, various situations can be addressed. Some or all of the above-described processing in the prediction unit may be performed using AI, or may be performed without using AI. For example, the prediction unit may input different scenario data into a generative AI and have the generative AI generate multiple prediction results.

The prediction unit can learn from past prediction results and continuously improve the prediction model. The prediction unit may, for example, improve the prediction model based on past prediction results. The prediction unit may also learn from past prediction results to improve prediction accuracy. The prediction unit may also introduce new prediction methods based on past prediction results. Thus, by learning from past prediction results, the prediction model can be continuously improved. Some or all of the above-described processing in the prediction unit may be performed using AI, or may be performed without using AI. For example, the prediction unit may input past prediction results into a generative AI and have the generative AI improve the prediction model.

The prediction unit can provide prediction results for different regions based on geographic information. The prediction unit may, for example, provide prediction results taking into account the weather conditions of different regions. The prediction unit may also provide prediction results taking into account the soil conditions of different regions. The prediction unit may also provide prediction results taking into account the vegetation conditions of different regions. Thus, by providing prediction results based on geographic information, predictions that take regional characteristics into account become possible. Some or all of the above-described processing in the prediction unit may be performed using AI, or may be performed without using AI. For example, the prediction unit may input geographic information into a generative AI and have the generative AI provide prediction results that take regional characteristics into account.

The prediction unit can refer to relevant market data to evaluate the economic impact of prediction results. The prediction unit may, for example, evaluate the economic impact of prediction results based on market data. The prediction unit may also refer to market data to evaluate the profitability of prediction results. The prediction unit may also evaluate the cost-effectiveness of prediction results based on market data. Thus, by referring to relevant market data, the economic impact of prediction results can be evaluated. Some or all of the above-described processing in the prediction unit may be performed using AI, or may be performed without using AI. For example, the prediction unit may input market data into a generative AI and have the generative AI evaluate the economic impact.

The prediction unit can provide prediction results in different formats to assist user understanding. The prediction unit may, for example, provide prediction results in graph format to make them visually easy to understand. The prediction unit may also provide prediction results in text format with detailed explanations. The prediction unit may also provide prediction results in animation format to make them dynamically easy to understand. Thus, by providing prediction results in different formats, user understanding is deepened. Some or all of the above-described processing in the prediction unit may be performed using AI, or may be performed without using AI. For example, the prediction unit may input prediction results into a generative AI and have the generative AI provide them in different formats.

The provision unit can propose specific agricultural measures based on prediction results. The provision unit may, for example, propose a measure to harvest in periods when the abundance of beneficial insects increases. The provision unit may also propose pest control measures in periods when the abundance of harmful insects increases. The provision unit may also propose the optimal timing for fertilization or irrigation based on prediction results. Thus, by proposing specific agricultural measures based on prediction results, agricultural efficiency is improved. Some or all of the above-described processing in the provision unit may be performed using AI, or may be performed without using AI. For example, the provision unit may input prediction results into a generative AI and have the generative AI propose specific agricultural measures.

The provision unit can provide customized advice based on the user's past behavior history. The provision unit may, for example, propose the optimal harvest timing based on the user's past harvest data. The provision unit may also propose the optimal pest control measures based on the user's past pest control history. The provision unit may also propose the optimal fertilization timing based on the user's past fertilization history. Thus, by providing customized advice based on the user's past behavior history, more appropriate measures can be taken. Some or all of the above-described processing in the provision unit may be performed using AI, or may be performed without using AI. For example, the provision unit may input the user's past behavior history into a generative AI and have the generative AI provide customized advice.

The provision unit can perform risk assessment based on prediction results and issue warnings to the user. The provision unit may, for example, issue a warning to the user if an increase in the abundance of harmful insects is predicted. The provision unit may also issue a warning to the user if worsening weather conditions are predicted. The provision unit may also issue a warning to the user if a decrease in yield is predicted. Thus, by performing risk assessment based on prediction results, appropriate warnings can be issued to the user. Some or all of the above-described processing in the provision unit may be performed using AI, or may be performed without using AI. For example, the provision unit may input prediction results into a generative AI and have the generative AI perform risk assessment and issue warnings.

The provision unit can provide information optimized for different devices. The provision unit may, for example, provide information optimized for smartphones. The provision unit may also provide information optimized for tablets. The provision unit may also provide information optimized for desktops. Thus, by supporting different devices, users can obtain information from various devices. Some or all of the above-described processing in the provision unit may be performed using AI, or may be performed without using AI. For example, the provision unit may input information for different devices into a generative AI and have the generative AI provide information optimized for the device.

The provision unit can continuously improve the information provided based on user feedback. The provision unit may, for example, improve the content of the information based on user feedback. The provision unit may also improve the method of providing information based on user feedback. The provision unit may also introduce new information provision methods based on user feedback. Thus, by continuously improving information based on user feedback, more appropriate information provision becomes possible. Some or all of the above-described processing in the provision unit may be performed using AI, or may be performed without using AI. For example, the provision unit may input user feedback data into a generative AI and have the generative AI improve the information.

The provision unit can propose marketing strategies based on prediction results and support sales promotion. The provision unit may, for example, propose the optimal sales timing based on prediction results. The provision unit may also propose target markets based on prediction results. The provision unit may also propose effective promotion strategies based on prediction results. Thus, by proposing marketing strategies based on prediction results, sales promotion is streamlined. Some or all of the above-described processing in the provision unit may be performed using AI, or may be performed without using AI. For example, the provision unit may input prediction results into a generative AI and have the generative AI propose marketing strategies.

The system according to the embodiment is not limited to the examples described above and can be variously modified, for example, as follows.

The collection unit can also monitor the soil components of farmland in real time and collect data. For example, the pH value, humidity, and nutrient content of the soil are measured by sensors, and the data is sent to a cloud server. The collection unit can also track changes in the soil over the long term and propose the timing of soil improvement to agricultural stakeholders. Thus, the state of the soil can always be grasped and appropriate agricultural measures can be taken.

The analysis unit can estimate the growth stage of crops based on the collected data and propose the optimal timing for fertilization or irrigation. For example, the analysis unit analyzes the color and shape of crop leaves to identify the growth stage. The analysis unit can also predict the optimal environmental conditions for crop growth by combining with weather data. Thus, crop growth can be optimized and yield maximized.

The prediction unit can predict the risk of pest outbreaks based on the collected data and issue early warnings to agricultural stakeholders. For example, the prediction unit predicts the timing of pest outbreaks by combining past data and weather conditions. The prediction unit can also propose appropriate pest control measures when the risk of pest outbreaks increases. Thus, pest damage can be minimized and crop quality maintained.

The provision unit can provide advice to agricultural stakeholders to optimize the harvest timing of crops based on the collected data. For example, the provision unit predicts the optimal harvest timing by combining crop growth data and weather data. The provision unit can also propose optimization of labor allocation according to the harvest timing. Thus, the efficiency of harvesting operations can be improved and yield maximized.

The collection unit can collect data under different weather conditions and analyze the impact of environmental changes. For example, the collection unit collects data during rainy weather and analyzes the behavioral patterns of beneficial and harmful insects. The collection unit may also collect data during clear weather and analyze the behavioral patterns of beneficial and harmful insects. Thus, by collecting data under different weather conditions, the impact of environmental changes can be analyzed.

The following is a brief description of the processing flow of Example 1 of the Embodiment.

Step 1: The collection unit collects data. The data may include, for example, sensor data, image data, text data, etc. The collection unit periodically observes the types, number of occurrences, occurrence times, and frequencies of beneficial and harmful insects using a fixed-point surveillance camera. The collection unit may also transmit data to a cloud server. For example, image data captured by a fixed-point surveillance camera is transmitted to a cloud server for storage.

Step 2: The analysis unit analyzes the data collected by the collection unit. The analysis is performed using, for example, machine learning or deep learning. The analysis unit analyzes data using machine learning algorithms or deep learning algorithms and may also combine different analysis algorithms to improve analysis accuracy.

Step 3: The prediction unit performs simulation prediction based on the analysis results obtained by the analysis unit. The simulation prediction may, for example, predict the correlation between the abundance of beneficial and harmful insects and the yield or production quality. The prediction unit predicts that an increase in the abundance of beneficial insects will increase the yield, or that an increase in the abundance of harmful insects will decrease the yield. The prediction unit may also provide multiple prediction results based on scenarios that take into account weather changes.

Step 4: The provision unit provides the prediction results obtained by the prediction unit. The provision is made, for example, to agricultural stakeholders. The provision unit provides the prediction results to agricultural stakeholders so that appropriate agricultural measures can be taken. The provision unit may also propose measures to improve the productivity of pesticide-free or organic farming. For example, the provision unit may propose measures such as harvesting in periods when the abundance of beneficial insects increases, or pest control measures in periods when the abundance of harmful insects increases.

### Example 2 of Embodiment

The agricultural support system according to the embodiment of the present invention is a system that monitors the types, number of occurrences, occurrence times, and frequencies of beneficial and harmful insects in farmland or cultivated land using fixed-point surveillance cameras and collects such data. The collected data is analyzed by AI, and the correlation between the abundance of beneficial and harmful insects and the yield or production quality is simulated and predicted. This makes it possible to improve the productivity of pesticide-free and organic farming. For example, the agricultural support system installs fixed-point surveillance cameras in farmland or cultivated land and periodically observes the types, number of occurrences, occurrence times, and frequencies of beneficial and harmful insects. For example, the camera takes images at regular intervals, and the images are analyzed to identify the types and numbers of beneficial and harmful insects. This data is transmitted to and stored on a cloud server. Next, the collected data is analyzed by AI. The AI simulates and predicts the correlation between the abundance of beneficial and harmful insects and the yield or production quality. For example, it is predicted that an increase in the abundance of beneficial insects will increase the yield, while an increase in the abundance of harmful insects will decrease the yield. Based on such simulation results, agricultural stakeholders can take measures to improve the productivity of pesticide-free and organic farming. Thus, the agricultural support system enables agricultural stakeholders to grasp the trends of beneficial and harmful insects in real time and take appropriate measures. In addition, simulation prediction by AI makes it possible to improve the productivity of pesticide-free and organic farming. For example, by harvesting in periods when the abundance of beneficial insects increases, the yield can be maximized. Also, by taking pest control measures in periods when the abundance of harmful insects increases, production quality can be maintained. In this way, the agricultural support system is extremely useful for agricultural stakeholders and serves as a powerful tool for improving the productivity of pesticide-free and organic farming.

The agricultural support system according to the embodiment includes a collection unit, an analysis unit, a prediction unit, and a provision unit. The collection unit collects data. The data may include, for example, sensor data, image data, text data, etc., but is not limited thereto. The collection unit may, for example, periodically observe the types, number of occurrences, occurrence times, and frequencies of beneficial and harmful insects using a fixed-point surveillance camera. The collection unit may also transmit data to a cloud server. For example, the collection unit may transmit image data captured by a fixed-point surveillance camera to a cloud server for storage. The analysis unit analyzes the data collected by the collection unit. The analysis may be performed using, for example, machine learning or deep learning, but is not limited thereto. For example, the analysis unit may analyze data using a machine learning algorithm. The analysis unit may also analyze data using a deep learning algorithm. The analysis unit may also combine different analysis algorithms to improve analysis accuracy. For example, the analysis unit may combine machine learning and deep learning to improve analysis accuracy. The prediction unit performs simulation prediction based on the analysis results obtained by the analysis unit. The simulation prediction may, for example, predict the correlation between the abundance of beneficial and harmful insects and the yield or production quality, but is not limited thereto. For example, the prediction unit may predict that an increase in the abundance of beneficial insects will increase the yield. The prediction unit may also predict that an increase in the abundance of harmful insects will decrease the yield. The prediction unit may also provide multiple prediction results based on different scenarios. For example, the prediction unit may provide prediction results based on scenarios that take into account weather changes. The provision unit provides the prediction results obtained by the prediction unit. The provision may be made, for example, to agricultural stakeholders, but is not limited thereto. For example, the provision unit provides the prediction results to agricultural stakeholders so that appropriate agricultural measures can be taken. The provision unit may also propose measures to improve the productivity of pesticide-free or organic farming. For example, the provision unit may propose measures such as harvesting in periods when the abundance of beneficial insects increases, or pest control measures in periods when the abundance of harmful insects increases. Thus, the agricultural support system according to the embodiment can efficiently perform data collection, analysis, simulation prediction, and provision. Some or all of the above-described processing in the provision unit may be performed using AI, or may be performed without using AI. For example, the provision unit may use an AI model that takes the prediction results obtained by the prediction unit as input and outputs countermeasure proposals for agricultural stakeholders to propose measures.

The collection unit can periodically observe the types, number of occurrences, occurrence times, and frequencies of beneficial and harmful insects using a fixed-point surveillance camera. The fixed-point surveillance camera may include, for example, high-resolution cameras, infrared cameras, 360-degree cameras, etc., but is not limited thereto. The collection unit may, for example, observe the types of beneficial and harmful insects using a high-resolution camera. The collection unit may also observe the trends of beneficial and harmful insects at night using an infrared camera. The collection unit may also observe the trends of beneficial and harmful insects over a wide area using a 360-degree camera. Thus, by using a fixed-point surveillance camera, the trends of beneficial and harmful insects can be accurately observed. Some or all of the above-described processing in the collection unit may be performed using AI, or may be performed without using AI. For example, the collection unit may input image data captured by a fixed-point surveillance camera into a generative AI and have the generative AI identify the types and numbers of beneficial and harmful insects.

The collection unit can transmit data to a cloud server. The cloud server may include, for example, AWS, Google Cloud, Microsoft Azure, etc., but is not limited thereto. The collection unit may, for example, transmit data using AWS. The collection unit may also transmit data using Google Cloud. The collection unit may also transmit data using Microsoft Azure. Thus, by transmitting data to a cloud server, data storage and analysis are streamlined. Some or all of the above-described processing in the collection unit may be performed using AI, or may be performed without using AI. For example, the collection unit may have a generative AI select the data to be transmitted to the cloud server.

The analysis unit can analyze data using machine learning or deep learning. Machine learning algorithms may include, for example, linear regression, decision trees, random forests, etc., but are not limited thereto. The analysis unit may, for example, analyze data using linear regression. The analysis unit may also analyze data using decision trees. The analysis unit may also analyze data using random forests. Deep learning algorithms may include, for example, neural networks, CNNs (convolutional neural networks), RNNs (recurrent neural networks), etc., but are not limited thereto. The analysis unit may, for example, analyze data using neural networks. The analysis unit may also analyze data using CNNs. The analysis unit may also analyze data using RNNs. Thus, by using machine learning or deep learning, the accuracy of data analysis is improved. Some or all of the above-described processing in the analysis unit may be performed using AI, or may be performed without using AI. For example, the analysis unit may input data obtained from the collection unit into a generative AI and have the generative AI perform data analysis.

The prediction unit can simulate and predict the correlation between the abundance of beneficial and harmful insects and the yield or production quality. Methods for measuring correlation may include, for example, correlation coefficients, regression analysis, factor analysis, etc., but are not limited thereto. The prediction unit may, for example, predict the correlation between the abundance of beneficial and harmful insects and the yield using a correlation coefficient. The prediction unit may also predict the correlation between the abundance of beneficial and harmful insects and the production quality using regression analysis. The prediction unit may also predict the correlation between the abundance of beneficial and harmful insects and the yield or production quality using factor analysis. Thus, by simulating and predicting the correlation between the abundance of beneficial and harmful insects and the yield or production quality, agricultural productivity can be improved. Some or all of the above-described processing in the prediction unit may be performed using AI, or may be performed without using AI. For example, the prediction unit may input the analysis results obtained from the analysis unit into a generative AI and have the generative AI perform simulation prediction of the correlation.

The provision unit can provide the prediction results to agricultural stakeholders. Agricultural stakeholders may include, for example, farmers, agricultural consultants, agricultural researchers, etc., but are not limited thereto. The provision unit may, for example, provide prediction results to farmers. The provision unit may also provide prediction results to agricultural consultants. The provision unit may also provide prediction results to agricultural researchers. Thus, by providing prediction results to agricultural stakeholders, appropriate agricultural measures can be taken. Some or all of the above-described processing in the provision unit may be performed using AI, or may be performed without using AI. For example, the provision unit may input the prediction results obtained from the prediction unit into a generative AI and have the generative AI execute the method of providing information to agricultural stakeholders.

The provision unit can propose measures to improve the productivity of pesticide-free or organic farming. The definition of pesticide-free may include, for example, not using specific pesticides, using natural pest control methods, etc., but is not limited thereto. The definition of organic farming may include, for example, meeting the standards for obtaining organic certification, not using chemical fertilizers or synthetic pesticides, etc., but is not limited thereto. The provision unit may, for example, propose a measure to harvest in periods when the abundance of beneficial insects increases as a pesticide-free measure. The provision unit may also propose pest control measures in periods when the abundance of harmful insects increases as an organic farming measure. The provision unit may also propose the timing of fertilization or irrigation to improve the productivity of pesticide-free or organic farming. For example, the provision unit may propose a measure to fertilize in periods when the abundance of beneficial insects increases. The provision unit may also propose a measure to irrigate in periods when the abundance of harmful insects increases. Thus, by proposing measures to improve the productivity of pesticide-free or organic farming, agricultural efficiency is improved. Some or all of the above-described processing in the provision unit may be performed using AI, or may be performed without using AI. For example, the provision unit may input the prediction results obtained from the prediction unit into a generative AI and have the generative AI execute proposals for pesticide-free or organic farming measures.

The collection unit can estimate the user's emotions and adjust the timing of data collection based on the estimated user emotions. The collection unit may, for example, reduce the frequency of data collection when the user is feeling stressed to reduce the user's burden. The collection unit may also increase the frequency of data collection when the user is relaxed to collect more detailed data. The collection unit may also shorten the timing of data collection when the user is in a hurry to quickly obtain data. Thus, by adjusting the timing of data collection according to the user's emotions, the user's burden can be reduced. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the collection unit may be performed using AI, or may be performed without using AI. For example, the collection unit may input the user's facial expression data into a generative AI and have the generative AI estimate the emotion.

The collection unit can learn the behavioral patterns of beneficial and harmful insects and automatically set the optimal observation timing. The collection unit may, for example, learn the time periods when beneficial insects are most active and collect data during those periods. The collection unit may also learn the time periods when harmful insects are expected to appear and collect data during those periods. The collection unit may also learn the seasonal behavioral patterns of beneficial and harmful insects and set the optimal observation timing. Thus, by learning the behavioral patterns of beneficial and harmful insects, the optimal observation timing can be set. Some or all of the above-described processing in the collection unit may be performed using AI, or may be performed without using AI. For example, the collection unit may input behavioral data of beneficial and harmful insects into a generative AI and have the generative AI set the optimal observation timing.

The collection unit can collect data under different weather conditions and analyze the impact of environmental changes. The collection unit may, for example, collect data during rainy weather and analyze the behavioral patterns of beneficial and harmful insects. The collection unit may also collect data during clear weather and analyze the behavioral patterns of beneficial and harmful insects. The collection unit may also collect data according to temperature changes and analyze the behavioral patterns of beneficial and harmful insects. Thus, by collecting data under different weather conditions, the impact of environmental changes can be analyzed. Some or all of the above-described processing in the collection unit may be performed using AI, or may be performed without using AI. For example, the collection unit may input weather data into a generative AI and have the generative AI analyze the impact of environmental changes.

The collection unit can cooperate multiple cameras to collect wide-area data and enable detailed spatial analysis. The collection unit may, for example, install multiple cameras and collect wide-area data. The collection unit may also integrate data between cameras and perform detailed spatial analysis. The collection unit may also adjust the positions of the cameras and set the optimal data collection range. Thus, by cooperating multiple cameras, wide-area data can be collected and detailed spatial analysis becomes possible. Some or all of the above-described processing in the collection unit may be performed using AI, or may be performed without using AI. For example, the collection unit may input data obtained from multiple cameras into a generative AI and have the generative AI perform spatial analysis.

The collection unit can estimate the user's emotions and determine the priority of data to be collected based on the estimated user emotions. The collection unit may, for example, prioritize the collection of only important data when the user is feeling stressed. The collection unit may also prioritize the collection of detailed data when the user is relaxed. The collection unit may also prioritize the collection of data that can be quickly collected when the user is in a hurry. Thus, by determining the priority of data to be collected according to the user's emotions, efficient data collection becomes possible. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the collection unit may be performed using AI, or may be performed without using AI. For example, the collection unit may input the user's facial expression data into a generative AI and have the generative AI estimate the emotion.

The collection unit can collect data from different regions based on geographic information and perform analysis that takes regional characteristics into account. The collection unit may, for example, collect data taking into account the weather conditions of different regions. The collection unit may also collect data taking into account the soil conditions of different regions. The collection unit may also collect data taking into account the vegetation conditions of different regions. Thus, by collecting data based on geographic information, analysis that takes regional characteristics into account becomes possible. Some or all of the above-described processing in the collection unit may be performed using AI, or may be performed without using AI. For example, the collection unit may input geographic information into a generative AI and have the generative AI perform data collection that takes regional characteristics into account.

The collection unit can collect information from social media to supplement information on the occurrence of beneficial and harmful insects. The collection unit may, for example, analyze posts on social media and collect information on the occurrence of beneficial and harmful insects. The collection unit may also analyze check-in information on social media and collect information on the occurrence of beneficial and harmful insects. The collection unit may also analyze image posts on social media and collect information on the occurrence of beneficial and harmful insects. Thus, by collecting information from social media, information on the occurrence of beneficial and harmful insects can be supplemented. Some or all of the above-described processing in the collection unit may be performed using AI, or may be performed without using AI. For example, the collection unit may input post data from social media into a generative AI and have the generative AI collect information on the occurrence of beneficial and harmful insects.

The collection unit can customize the collection method based on past data to achieve efficient data collection. The collection unit may, for example, analyze past data and set the optimal data collection method. The collection unit may also adjust the collection frequency based on past data. The collection unit may also adjust the collection range based on past data. Thus, by customizing the collection method based on past data, efficient data collection becomes possible. Some or all of the above-described processing in the collection unit may be performed using AI, or may be performed without using AI. For example, the collection unit may input past data into a generative AI and have the generative AI customize the collection method.

The analysis unit can estimate the user's emotions and adjust the method of presenting analysis results based on the estimated user emotions. The analysis unit may, for example, provide simple and highly visible analysis results when the user is nervous. The analysis unit may also provide detailed analysis results when the user is relaxed. The analysis unit may also provide analysis results that focus on key points when the user is in a hurry. Thus, by adjusting the method of presenting analysis results according to the user's emotions, user understanding is deepened. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the analysis unit may be performed using AI, or may be performed without using AI. For example, the analysis unit may input the user's facial expression data into a generative AI and have the generative AI estimate the emotion.

The analysis unit can perform detailed behavioral analysis based on ecological information of beneficial and harmful insects. The analysis unit may, for example, analyze the activity time zones and behavioral patterns based on the ecological information of beneficial insects. The analysis unit may also analyze the occurrence times and behavioral patterns based on the ecological information of harmful insects. The analysis unit may also analyze interactions based on the ecological information of beneficial and harmful insects. Thus, by performing detailed behavioral analysis based on the ecological information of beneficial and harmful insects, analysis accuracy is improved. Some or all of the above-described processing in the analysis unit may be performed using AI, or may be performed without using AI. For example, the analysis unit may input ecological data of beneficial and harmful insects into a generative AI and have the generative AI perform behavioral analysis.

The analysis unit can combine different analysis algorithms to improve analysis accuracy. The analysis unit may, for example, combine machine learning and deep learning to improve analysis accuracy. The analysis unit may also combine different machine learning algorithms to improve analysis accuracy. The analysis unit may also combine different data analysis methods to improve analysis accuracy. Thus, by combining different analysis algorithms, analysis accuracy is improved. Some or all of the above-described processing in the analysis unit may be performed using AI, or may be performed without using AI. For example, the analysis unit may input different analysis algorithms into a generative AI and have the generative AI improve analysis accuracy.

The analysis unit can learn from past analysis results and continuously improve the analysis model. The analysis unit may, for example, improve the analysis model based on past analysis results. The analysis unit may also learn from past analysis results to improve analysis accuracy. The analysis unit may also introduce new analysis methods based on past analysis results. Thus, by learning from past analysis results, the analysis model can be continuously improved. Some or all of the above-described processing in the analysis unit may be performed using AI, or may be performed without using AI. For example, the analysis unit may input past analysis results into a generative AI and have the generative AI improve the analysis model.

The analysis unit can estimate the user's emotions and adjust the level of detail of analysis results based on the estimated user emotions. The analysis unit may, for example, provide simple and highly visible analysis results when the user is nervous. The analysis unit may also provide detailed analysis results when the user is relaxed. The analysis unit may also provide analysis results that focus on key points when the user is in a hurry. Thus, by adjusting the level of detail of analysis results according to the user's emotions, user understanding is deepened. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the analysis unit may be performed using AI, or may be performed without using AI. For example, the analysis unit may input the user's facial expression data into a generative AI and have the generative AI estimate the emotion.

The analysis unit can integrate different data sources for analysis. The analysis unit may, for example, integrate weather data and analyze the behavioral patterns of beneficial and harmful insects. The analysis unit may also integrate soil data and analyze the behavioral patterns of beneficial and harmful insects. The analysis unit may also integrate weather data and soil data and analyze the behavioral patterns of beneficial and harmful insects. Thus, by integrating different data sources, analysis accuracy is improved. Some or all of the above-described processing in the analysis unit may be performed using AI, or may be performed without using AI. For example, the analysis unit may input weather data and soil data into a generative AI and have the generative AI perform integrated data analysis.

The analysis unit can refer to relevant academic papers to improve the reliability of analysis results. The analysis unit may, for example, refer to academic papers on beneficial and harmful insects to improve the reliability of analysis results. The analysis unit may also refer to academic papers on weather data to improve the reliability of analysis results. The analysis unit may also refer to academic papers on soil data to improve the reliability of analysis results. Thus, by referring to relevant academic papers, the reliability of analysis results is improved. Some or all of the above-described processing in the analysis unit may be performed using AI, or may be performed without using AI. For example, the analysis unit may input academic paper data into a generative AI and have the generative AI improve the reliability of analysis results.

The analysis unit can visualize analysis results so that users can intuitively understand them. The analysis unit may, for example, visualize analysis results in graphs or charts. The analysis unit may also display analysis results on a map so that users can intuitively understand them. The analysis unit may also visualize analysis results with animations so that users can intuitively understand them. Thus, by visualizing analysis results, users can intuitively understand them more easily. Some or all of the above-described processing in the analysis unit may be performed using AI, or may be performed without using AI. For example, the analysis unit may input analysis results into a generative AI and have the generative AI perform visualization.

The prediction unit can estimate the user's emotions and adjust the method of displaying prediction results based on the estimated user emotions. The prediction unit may, for example, provide simple and highly visible prediction results when the user is nervous. The prediction unit may also provide detailed prediction results when the user is relaxed. The prediction unit may also provide prediction results that focus on key points when the user is in a hurry. Thus, by adjusting the method of displaying prediction results according to the user's emotions, user understanding is deepened. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the prediction unit may be performed using AI, or may be performed without using AI. For example, the prediction unit may input the user's facial expression data into a generative AI and have the generative AI estimate the emotion.

The prediction unit can perform long-term prediction taking into account the seasonal variations of beneficial and harmful insects. The prediction unit may, for example, take into account the seasonal variations of beneficial insects and perform long-term prediction. The prediction unit may also take into account the seasonal variations of harmful insects and perform long-term prediction. The prediction unit may also take into account the seasonal variations of both beneficial and harmful insects and perform long-term prediction. Thus, by taking into account the seasonal variations of beneficial and harmful insects, long-term prediction becomes possible. Some or all of the above-described processing in the prediction unit may be performed using AI, or may be performed without using AI. For example, the prediction unit may input seasonal variation data into a generative AI and have the generative AI perform long-term prediction.

The prediction unit can provide multiple prediction results based on different scenarios. The prediction unit may, for example, provide prediction results based on scenarios that take into account weather changes. The prediction unit may also provide prediction results based on scenarios that take into account pesticide use. The prediction unit may also provide prediction results based on scenarios that take into account both weather changes and pesticide use. Thus, by providing multiple prediction results based on different scenarios, various situations can be addressed. Some or all of the above-described processing in the prediction unit may be performed using AI, or may be performed without using AI. For example, the prediction unit may input different scenario data into a generative AI and have the generative AI generate multiple prediction results.

The prediction unit can learn from past prediction results and continuously improve the prediction model. The prediction unit may, for example, improve the prediction model based on past prediction results. The prediction unit may also learn from past prediction results to improve prediction accuracy. The prediction unit may also introduce new prediction methods based on past prediction results. Thus, by learning from past prediction results, the prediction model can be continuously improved. Some or all of the above-described processing in the prediction unit may be performed using AI, or may be performed without using AI. For example, the prediction unit may input past prediction results into a generative AI and have the generative AI improve the prediction model.

The prediction unit can estimate the user's emotions and determine the priority of prediction results based on the estimated user emotions. The prediction unit may, for example, prioritize providing important prediction results when the user is nervous. The prediction unit may also prioritize providing detailed prediction results when the user is relaxed. The prediction unit may also prioritize providing prediction results that can be delivered quickly when the user is in a hurry. Thus, by determining the priority of prediction results according to the user's emotions, important information can be provided preferentially. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the prediction unit may be performed using AI, or may be performed without using AI. For example, the prediction unit may input the user's facial expression data into a generative AI and have the generative AI estimate the emotion.

The prediction unit can provide prediction results for different regions based on geographic information. The prediction unit may, for example, provide prediction results taking into account the weather conditions of different regions. The prediction unit may also provide prediction results taking into account the soil conditions of different regions. The prediction unit may also provide prediction results taking into account the vegetation conditions of different regions. Thus, by providing prediction results based on geographic information, predictions that take regional characteristics into account become possible. Some or all of the above-described processing in the prediction unit may be performed using AI, or may be performed without using AI. For example, the prediction unit may input geographic information into a generative AI and have the generative AI provide prediction results that take regional characteristics into account.

The prediction unit can refer to relevant market data to evaluate the economic impact of prediction results. The prediction unit may, for example, evaluate the economic impact of prediction results based on market data. The prediction unit may also refer to market data to evaluate the profitability of prediction results. The prediction unit may also evaluate the cost-effectiveness of prediction results based on market data. Thus, by referring to relevant market data, the economic impact of prediction results can be evaluated. Some or all of the above-described processing in the prediction unit may be performed using AI, or may be performed without using AI. For example, the prediction unit may input market data into a generative AI and have the generative AI evaluate the economic impact.

The prediction unit can provide prediction results in different formats to assist user understanding. The prediction unit may, for example, provide prediction results in graph format to make them visually easy to understand. The prediction unit may also provide prediction results in text format with detailed explanations. The prediction unit may also provide prediction results in animation format to make them dynamically easy to understand. Thus, by providing prediction results in different formats, user understanding is deepened. Some or all of the above-described processing in the prediction unit may be performed using AI, or may be performed without using AI. For example, the prediction unit may input prediction results into a generative AI and have the generative AI provide them in different formats.

The provision unit can estimate the user's emotions and adjust the method of presenting information based on the estimated user emotions. The provision unit may, for example, provide simple and highly visible information when the user is nervous. The provision unit may also provide detailed information when the user is relaxed. The provision unit may also provide information that focuses on key points when the user is in a hurry. Thus, by adjusting the method of presenting information according to the user's emotions, user understanding is deepened. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the provision unit may be performed using AI, or may be performed without using AI. For example, the provision unit may input the user's facial expression data into a generative AI and have the generative AI estimate the emotion.

The provision unit can propose specific agricultural measures based on prediction results. The provision unit may, for example, propose a measure to harvest in periods when the abundance of beneficial insects increases. The provision unit may also propose pest control measures in periods when the abundance of harmful insects increases. The provision unit may also propose the optimal timing for fertilization or irrigation based on prediction results. Thus, by proposing specific agricultural measures based on prediction results, agricultural efficiency is improved. Some or all of the above-described processing in the provision unit may be performed using AI, or may be performed without using AI. For example, the provision unit may input prediction results into a generative AI and have the generative AI propose specific agricultural measures.

The provision unit can provide customized advice based on the user's past behavior history. The provision unit may, for example, propose the optimal harvest timing based on the user's past harvest data. The provision unit may also propose the optimal pest control measures based on the user's past pest control history. The provision unit may also propose the optimal fertilization timing based on the user's past fertilization history. Thus, by providing customized advice based on the user's past behavior history, more appropriate measures can be taken. Some or all of the above-described processing in the provision unit may be performed using AI, or may be performed without using AI. For example, the provision unit may input the user's past behavior history into a generative AI and have the generative AI provide customized advice.

The provision unit can perform risk assessment based on prediction results and issue warnings to the user. The provision unit may, for example, issue a warning to the user if an increase in the abundance of harmful insects is predicted. The provision unit may also issue a warning to the user if worsening weather conditions are predicted. The provision unit may also issue a warning to the user if a decrease in yield is predicted. Thus, by performing risk assessment based on prediction results, appropriate warnings can be issued to the user. Some or all of the above-described processing in the provision unit may be performed using AI, or may be performed without using AI. For example, the provision unit may input prediction results into a generative AI and have the generative AI perform risk assessment and issue warnings.

The provision unit can estimate the user's emotions and determine the priority of information to be provided based on the estimated user emotions. The provision unit may, for example, prioritize providing important information when the user is nervous. The provision unit may also prioritize providing detailed information when the user is relaxed. The provision unit may also prioritize providing information that can be delivered quickly when the user is in a hurry. Thus, by determining the priority of information according to the user's emotions, important information can be provided preferentially. Emotion estimation is realized, for example, by using an emotion engine or a generative AI with emotion estimation functionality. The generative AI may be a text generation AI (e.g., LLM) or a multimodal generative AI, but is not limited thereto. Some or all of the above-described processing in the provision unit may be performed using AI, or may be performed without using AI. For example, the provision unit may input the user's facial expression data into a generative AI and have the generative AI estimate the emotion.

The provision unit can provide information optimized for different devices. The provision unit may, for example, provide information optimized for smartphones. The provision unit may also provide information optimized for tablets. The provision unit may also provide information optimized for desktops. Thus, by supporting different devices, users can obtain information from various devices. Some or all of the above-described processing in the provision unit may be performed using AI, or may be performed without using AI. For example, the provision unit may input information for different devices into a generative AI and have the generative AI provide information optimized for the device.

The provision unit can continuously improve the information provided based on user feedback. The provision unit may, for example, improve the content of the information based on user feedback. The provision unit may also improve the method of providing information based on user feedback. The provision unit may also introduce new information provision methods based on user feedback. Thus, by continuously improving information based on user feedback, more appropriate information provision becomes possible. Some or all of the above-described processing in the provision unit may be performed using AI, or may be performed without using AI. For example, the provision unit may input user feedback data into a generative AI and have the generative AI improve the information.

The provision unit can propose marketing strategies based on prediction results and support sales promotion. The provision unit may, for example, propose the optimal sales timing based on prediction results. The provision unit may also propose target markets based on prediction results. The provision unit may also propose effective promotion strategies based on prediction results. Thus, by proposing marketing strategies based on prediction results, sales promotion is streamlined. Some or all of the above-described processing in the provision unit may be performed using AI, or may be performed without using AI. For example, the provision unit may input prediction results into a generative AI and have the generative AI propose marketing strategies.

### Hardware Guarantee 1-1

Each of the multiple elements including the above-described collection unit, analysis unit, prediction unit, and provision unit is realized by at least one of, for example, the smart device 14 and the data processing device 12. For example, the collection unit observes the types, number of occurrences, occurrence times, and frequencies of beneficial and harmful insects using the camera 42 of the smart device 14 and transmits the data to the data processing device 12. The analysis unit is realized, for example, by the specific processing unit 290 of the data processing device 12 and analyzes the collected data. The prediction unit is realized, for example, by the specific processing unit 290 of the data processing device 12 and performs simulation prediction based on the analysis results. The provision unit is realized, for example, by the control unit 46A of the smart device 14 and provides the prediction results to agricultural stakeholders. In addition, the collection unit can estimate the user's emotions and adjust the timing of data collection based on the estimated emotions. Emotion estimation is realized, for example, by the specific processing unit 290 of the data processing device 12.

### Hardware Guarantee 1-2

Each of the multiple elements including the above-described collection unit, analysis unit, prediction unit, and provision unit is realized by at least one of, for example, the smart glasses 214 and the data processing device 12. For example, the collection unit observes the types, number of occurrences, occurrence times, and frequencies of beneficial and harmful insects using the camera 42 of the smart glasses 214 and transmits the data to the data processing device 12. The analysis unit is realized, for example, by the specific processing unit 290 of the data processing device 12 and analyzes the collected data. The prediction unit is realized, for example, by the specific processing unit 290 of the data processing device 12 and performs simulation prediction based on the analysis results. The provision unit is realized, for example, by the control unit 46A of the smart glasses 214 and provides the prediction results to agricultural stakeholders. In addition, the collection unit can estimate the user's emotions and adjust the timing of data collection based on the estimated emotions. Emotion estimation is realized, for example, by the specific processing unit 290 of the data processing device 12.

### Hardware Guarantee 1-3

Each of the multiple elements including the above-described collection unit, analysis unit, prediction unit, and provision unit is realized by at least one of, for example, the headset-type terminal 314 and the data processing device 12. For example, the collection unit observes the types, number of occurrences, occurrence times, and frequencies of beneficial and harmful insects using the camera 42 of the headset-type terminal 314 and transmits the data to the data processing device 12. The analysis unit is realized, for example, by the specific processing unit 290 of the data processing device 12 and analyzes the collected data. The prediction unit is realized, for example, by the specific processing unit 290 of the data processing device 12 and performs simulation prediction based on the analysis results. The provision unit is realized, for example, by the control unit 46A of the headset-type terminal 314 and provides the prediction results to agricultural stakeholders. In addition, the collection unit can estimate the user's emotions and adjust the timing of data collection based on the estimated emotions. Emotion estimation is realized, for example, by the specific processing unit 290 of the data processing device 12.

### Hardware Guarantee 1-4

Each of the multiple elements including the above-described collection unit, analysis unit, prediction unit, and provision unit is realized by at least one of, for example, the robot 414 and the data processing device 12. For example, the collection unit observes the types, number of occurrences, occurrence times, and frequencies of beneficial and harmful insects using the camera 42 of the robot 414 and transmits the data to the data processing device 12. The analysis unit is realized, for example, by the specific processing unit 290 of the data processing device 12 and analyzes the collected data. The prediction unit is realized, for example, by the specific processing unit 290 of the data processing device 12 and performs simulation prediction based on the analysis results. The provision unit is realized, for example, by the control unit 46A of the robot 414 and provides the prediction results to agricultural stakeholders. In addition, the collection unit can estimate the user's emotions and adjust the timing of data collection based on the estimated emotions. Emotion estimation is realized, for example, by the specific processing unit 290 of the data processing device 12.

The system according to the embodiment is not limited to the examples described above and can be variously modified, for example, as follows.

The collection unit can also monitor the soil components of farmland in real time and collect data. For example, the pH value, humidity, and nutrient content of the soil are measured by sensors, and the data is sent to a cloud server. The collection unit can also track changes in the soil over the long term and propose the timing of soil improvement to agricultural stakeholders. Thus, the state of the soil can always be grasped and appropriate agricultural measures can be taken.

The analysis unit can estimate the growth stage of crops based on the collected data and propose the optimal timing for fertilization or irrigation. For example, the analysis unit analyzes the color and shape of crop leaves to identify the growth stage. The analysis unit can also predict the optimal environmental conditions for crop growth by combining with weather data. Thus, crop growth can be optimized and yield maximized.

The prediction unit can predict the risk of pest outbreaks based on the collected data and issue early warnings to agricultural stakeholders. For example, the prediction unit predicts the timing of pest outbreaks by combining past data and weather conditions. The prediction unit can also propose appropriate pest control measures when the risk of pest outbreaks increases. Thus, pest damage can be minimized and crop quality maintained.

The provision unit can provide advice to agricultural stakeholders to optimize the harvest timing of crops based on the collected data. For example, the provision unit predicts the optimal harvest timing by combining crop growth data and weather data. The provision unit can also propose optimization of labor allocation according to the harvest timing. Thus, the efficiency of harvesting operations can be improved and yield maximized.

The collection unit can estimate the user's emotions and adjust the timing of data collection based on the estimated user emotions. For example, when the user is feeling stressed, the frequency of data collection is reduced to lessen the user's burden. When the user is relaxed, the frequency of data collection is increased to collect more detailed data. Thus, by adjusting the timing of data collection according to the user's emotions, the user's burden can be reduced.

The analysis unit can estimate the user's emotions and adjust the method of presenting analysis results based on the estimated user emotions. For example, when the user is nervous, simple and highly visible analysis results are provided. When the user is relaxed, detailed analysis results can also be provided. Thus, by adjusting the method of presenting analysis results according to the user's emotions, user understanding is deepened.

The prediction unit can estimate the user's emotions and adjust the method of displaying prediction results based on the estimated user emotions. For example, when the user is nervous, simple and highly visible prediction results are provided. When the user is relaxed, detailed prediction results can also be provided. Thus, by adjusting the method of displaying prediction results according to the user's emotions, user understanding is deepened.

The provision unit can estimate the user's emotions and adjust the method of presenting information based on the estimated user emotions. For example, when the user is nervous, simple and highly visible information is provided. When the user is relaxed, detailed information can also be provided. Thus, by adjusting the method of presenting information according to the user's emotions, user understanding is deepened.

The provision unit can estimate the user's emotions and determine the priority of information to be provided based on the estimated user emotions. For example, when the user is nervous, important information is provided preferentially. When the user is relaxed, detailed information can also be provided preferentially. Thus, by determining the priority of information according to the user's emotions, important information can be provided preferentially.

The collection unit can collect data under different weather conditions and analyze the impact of environmental changes. For example, the collection unit collects data during rainy weather and analyzes the behavioral patterns of beneficial and harmful insects. The collection unit may also collect data during clear weather and analyze the behavioral patterns of beneficial and harmful insects. Thus, by collecting data under different weather conditions, the impact of environmental changes can be analyzed.

The following is a brief description of the processing flow of Example 2 of the Embodiment.

Step 1: The collection unit collects data. The data may include, for example, sensor data, image data, text data, etc. The collection unit periodically observes the types, number of occurrences, occurrence times, and frequencies of beneficial and harmful insects using a fixed-point surveillance camera. The collection unit may also transmit data to a cloud server. For example, image data captured by a fixed-point surveillance camera is transmitted to a cloud server for storage.

Step 2: The analysis unit analyzes the data collected by the collection unit. The analysis is performed using, for example, machine learning or deep learning. The analysis unit analyzes data using machine learning algorithms or deep learning algorithms and may also combine different analysis algorithms to improve analysis accuracy.

Step 3: The prediction unit performs simulation prediction based on the analysis results obtained by the analysis unit. The simulation prediction may, for example, predict the correlation between the abundance of beneficial and harmful insects and the yield or production quality. The prediction unit predicts that an increase in the abundance of beneficial insects will increase the yield, or that an increase in the abundance of harmful insects will decrease the yield. The prediction unit may also provide multiple prediction results based on scenarios that take into account weather changes.

Step 4: The provision unit provides the prediction results obtained by the prediction unit. The provision is made, for example, to agricultural stakeholders. The provision unit provides the prediction results to agricultural stakeholders so that appropriate agricultural measures can be taken. The provision unit may also propose measures to improve the productivity of pesticide-free or organic farming. For example, the provision unit may propose measures such as harvesting in periods when the abundance of beneficial insects increases, or pest control measures in periods when the abundance of harmful insects increases.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the devices or control units is not limited to the examples described above and can be variously modified.

### Second Embodiment

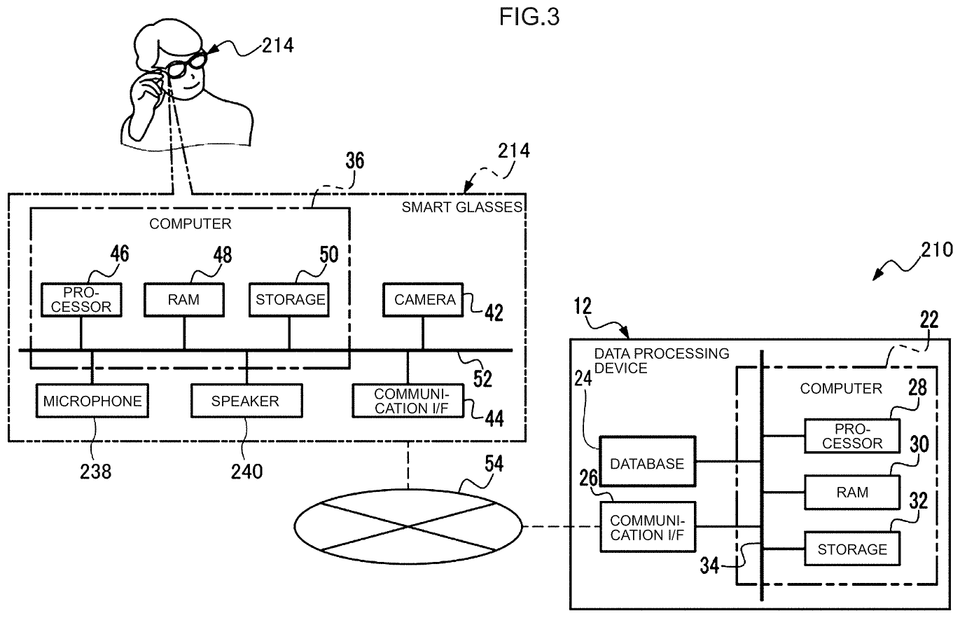

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

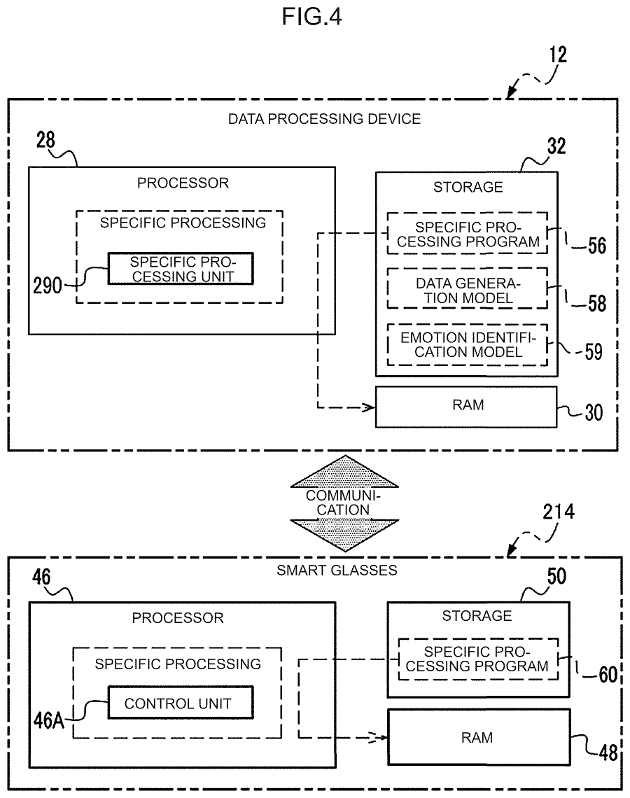

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the devices or control units is not limited to the examples described above and can be variously modified.

### Third Embodiment

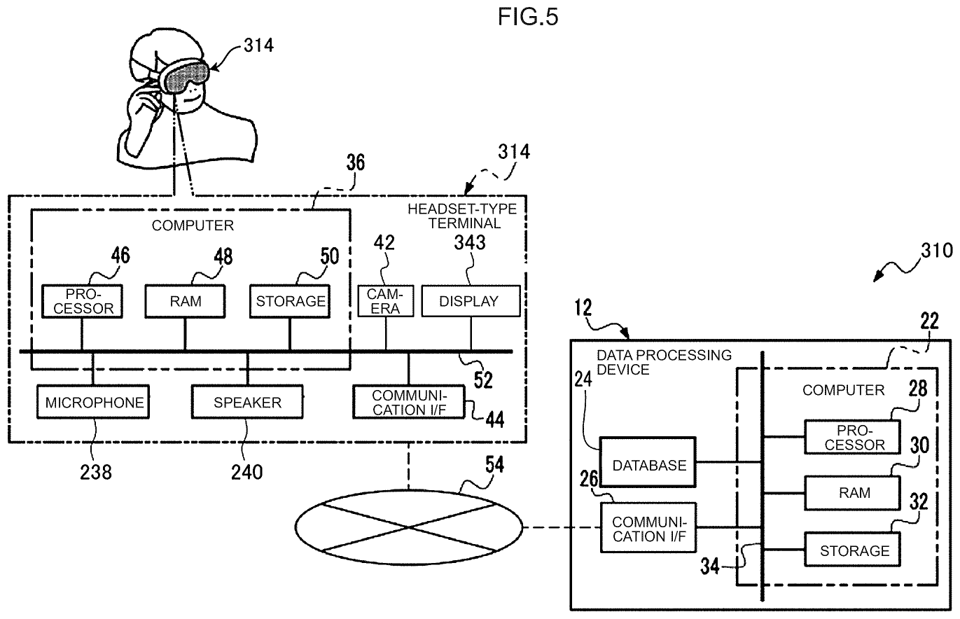

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

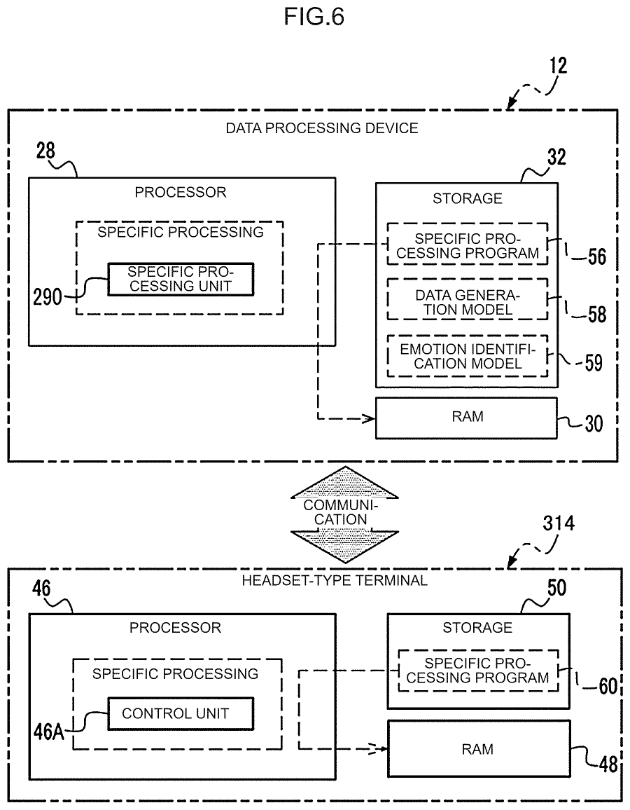

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the devices or control units is not limited to the examples described above and can be variously modified.

### Fourth Embodiment

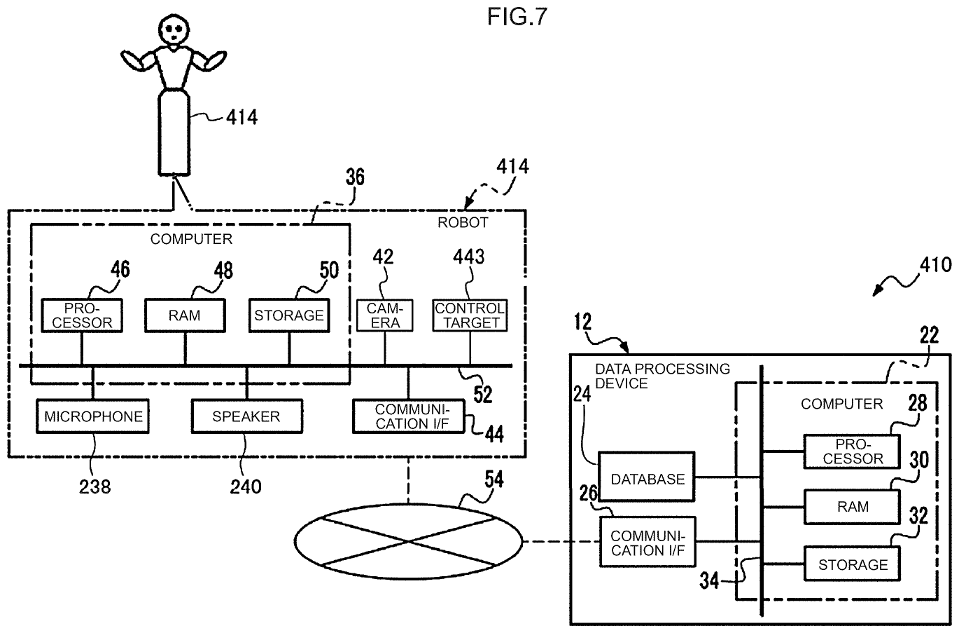

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

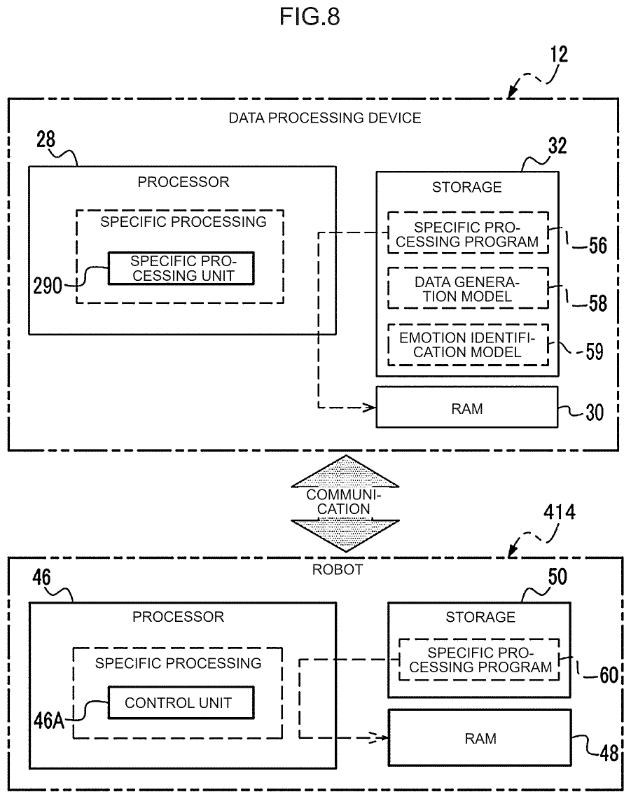

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the devices or control units is not limited to the examples described above and can be variously modified.

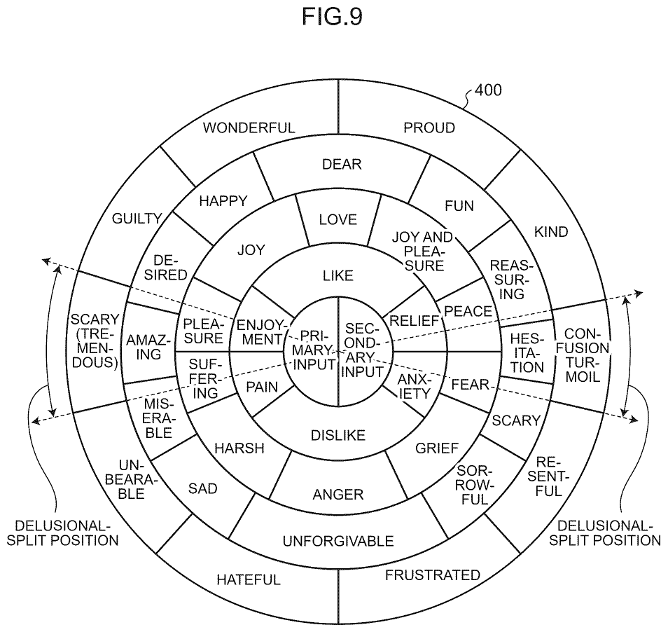

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

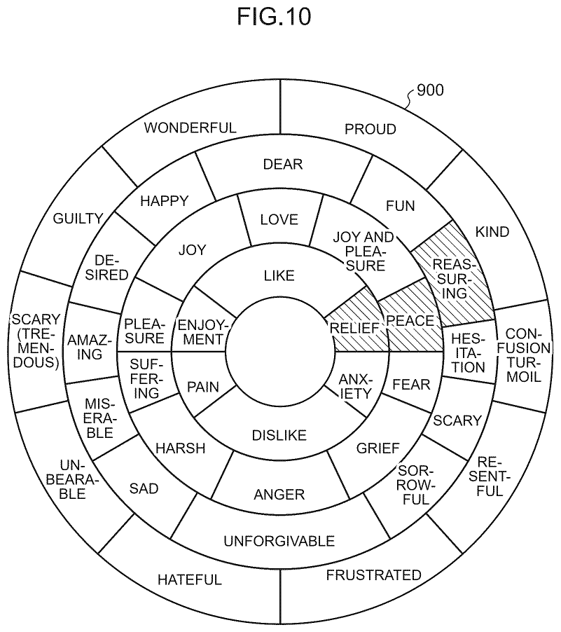

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: a collection unit that collects data; an analysis unit that analyzes the data collected by the collection unit; a prediction unit that performs simulation prediction based on the analysis results obtained by the analysis unit; and a provision unit that provides the prediction results obtained by the prediction unit.

2. The system according to claim 1, wherein the collection unit periodically observes the types, number of occurrences, occurrence times, and frequencies of beneficial and harmful insects using a fixed-point surveillance camera.

3. The system according to claim 1, wherein the collection unit transmits data to a cloud server.

4. The system according to claim 1, wherein the analysis unit analyzes data using machine learning or deep learning.

5. The system according to claim 1, wherein the prediction unit performs simulation prediction of the correlation between the abundance of beneficial and harmful insects and the yield or production quality.

6. The system according to claim 1, wherein the provision unit provides the prediction results to agricultural stakeholders.

7. The system according to claim 1, wherein the provision unit proposes measures to improve the productivity of pesticide-free or organic farming.

8. The system according to claim 1, wherein the collection unit estimates the user's emotions and adjusts the timing of data collection based on the estimated user emotions.
